(19) United States
(12) Patent Application Publication
(10) Pub. No.: US 2019/0090082 A1
(43) Pub. Date: Mar. 21, 2019

(54) SYSTEMS AND METHODS FOR IMPROVING RECEPTION OF ADVERTISING PACKETS

(71) Applicant: QUALCOMM Incorporated, San Diego, CA (US)

(72) Inventors: Robert Ganton, San Diego, CA (US); Robert Ballam, Eatons Hill (AU)

(21) Appl. No.: 15/824,408

(22) Filed: Nov. 28, 2017

Related U.S. Application Data
(60) Provisional application No. 62/561,056, filed on Sep. 20, 2017.

(51) Int. Cl. H04W 4/00; H04W 4/20; H04W 28/02

(52) U.S. Cl. CPC H04W 4/008; G06Q 10/0833; H04W 28/0221; H04W 4/206

(57) ABSTRACT

A method by a wireless communication device is described. The method includes transmitting a first sequence of high-power advertising packets. The method also includes transmitting a second sequence of low-power advertising packets at a same advertising rate as the high-power advertising packets. The high-power advertising packets and the low-power advertising packets include the same advertising information. The first sequence and the second sequence repeat in one or more cycles.

### RELATED APPLICATIONS

This application is related to and claims priority from U.S. Provisional Patent Application Ser. No. 62/561,056, filed Sep. 20, 2017, for “SYSTEMS AND METHODS FOR IMPROVING RECEPTION OF ADVERTISING PACKETS.”

### TECHNICAL FIELD

The present disclosure relates generally to communications. More specifically, the present disclosure relates to systems and methods for improving reception of advertising packets.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or more reliably are often sought after.

Some electronic devices communicate with other electronic devices. These electronic devices may transmit and/or receive wireless signals. For example, a wireless communication device may communicate with another wireless communication device using radio frequency communication or magnetically coupled communication.

As wireless communication devices have become smaller and smaller, particular challenges have arisen in wireless communications. For example, a wireless communication device may transmit advertising packets to make its presence known to other wireless communication devices. However, in an environment where many wireless communication devices are advertising, the advertising packets may be missed due to radio channel congestion. Therefore, systems and methods for improving reception of advertising packets may be beneficial.

### SUMMARY

A method by a wireless communication device is described. The method includes transmitting a first sequence of high-power advertising packets. The method also includes transmitting a second sequence of low-power advertising packets at a same advertising rate as the high-power advertising packets. The high-power advertising packets and the low-power advertising packets include the same advertising information. The first sequence and the second sequence repeat in one or more cycles.

The first sequence may include a number of high-power advertising packets and the second sequence may include a number of low-power advertising packets. The number of low-power advertising packets may be greater than the number of high-power advertising packets.

In some implementations, the first sequence includes between 5 and 10 high-power advertising packets. In some implementations, a ratio of low-power advertising packets to high-power advertising packets is approximately 10:1.

The ratio of high-power advertising packets to low-power advertising packets may be based on an expected density of advertising devices in an area. The ratio of high-power advertising packets to low-power advertising packets may be based on a package type to which the wireless communication device is attached.

A low transmit (TX) power level of the low-power advertising packets may be approximately 10 to 20 decibels (dB) below a high TX power level of the high-power advertising packets.

In some implementations, the wireless communication device may be a Bluetooth low energy (BLE) device. In some implementations, the wireless communication device may be a radio-frequency identification (RFID) device.

In some implementations, the wireless communication device may be configured to attach to an object for inventory tracking. The wireless communication device may be configured as a shipping label for package tracking. In some implementations, the wireless communication device may be a package tracking beacon having a transmitter and no receiver.

A wireless communication device is also described. The wireless communication device may include a processor and a memory in electronic communication with the processor. Instructions stored in the memory are executable by the processor to transmit a first sequence of high-power advertising packets. The instructions are also executable to transmit a second sequence of low-power advertising packets at a same advertising rate as the high-power advertising packets. The high-power advertising packets and the low-power advertising packets include the same advertising information. The first sequence and the second sequence repeat in one or more cycles.

A non-transitory tangible computer readable medium is also described. The computer readable medium stores computer executable code for causing a wireless communication device to transmit a first sequence of high-power advertising packets. The computer readable medium also stores computer executable code for causing the wireless communication device to transmit a second sequence of low-power advertising packets at a same advertising rate as the high-power advertising packets. The high-power advertising packets and the low-power advertising packets include the same advertising information. The first sequence and the second sequence repeat in one or more cycles.

An apparatus for wireless communication is also described. The apparatus includes means for transmitting a first sequence of high-power advertising packets. The apparatus also includes means for transmitting a second sequence of low-power advertising packets at a same advertising rate as the high-power advertising packets. The high-power advertising packets and the low-power advertising packets include the same advertising information. The first sequence and the second sequence repeat in one or more cycles.

### BRIEF DESCRIPTION OF THE DRAWINGS

FIG. 1 is a block diagram illustrating a wireless communication device configured to transmit advertising packets for improved reception by a scanner;

FIG. 2 is a flow diagram illustrating one configuration of a method for improving reception of advertising packets sent by a wireless communication device;

FIG. 3 is a flow diagram illustrating another configuration of a method for improving reception of advertising packets sent by a wireless communication device;

FIG. 4 is a block diagram illustrating a package tracking beacon;

FIG. 5 is a flow diagram illustrating one configuration of a method for improving reception of advertising packets sent by a package tracking beacon;

FIG. 6 is a graph illustrating advertising packet transmit pulses according to a modulated power level; and

FIG. 7 illustrates certain components that may be included within a wireless communication device.

### DETAILED DESCRIPTION

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

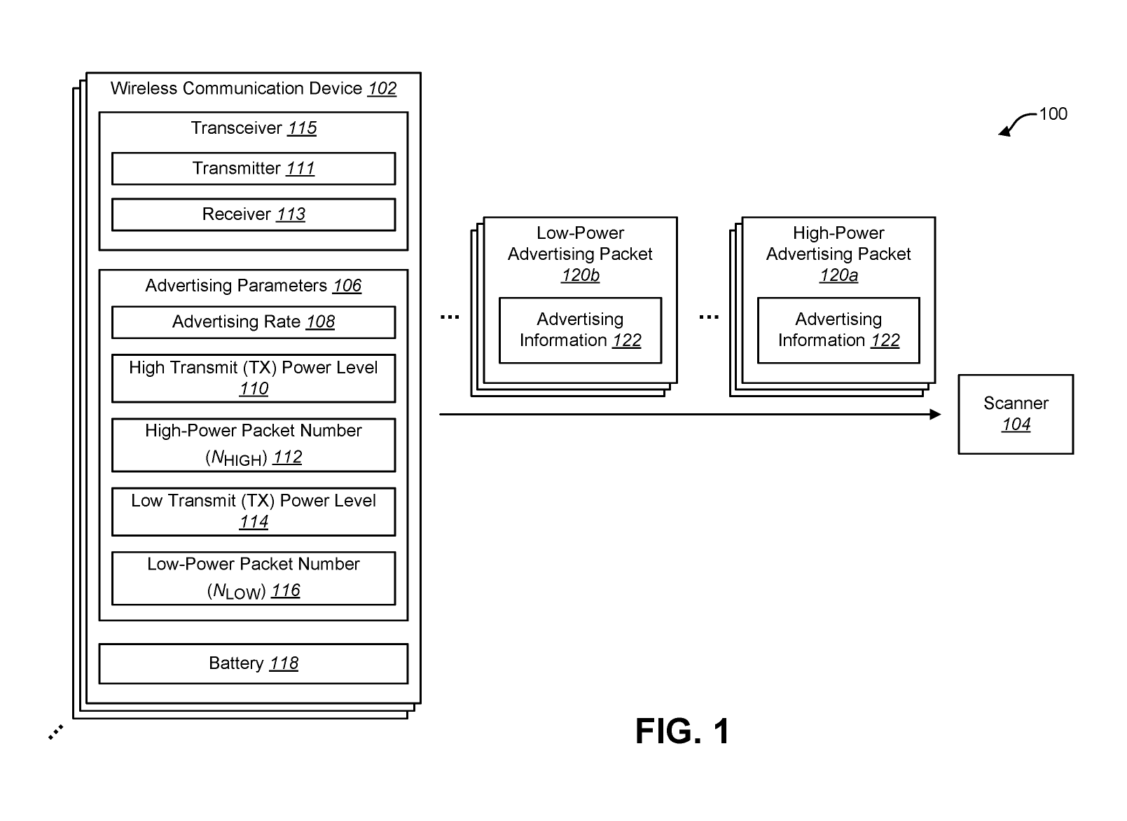

FIG. 1 is a block diagram illustrating a wireless communication device 102 configured to transmit advertising packets 120 for improved reception by a scanner 104. The wireless communication device 102 may be included in a wireless communication system 100. Wireless communication systems 100 are widely deployed to provide various types of communication content such as voice, data and so on. The wireless communication system 100 may include a scanner 104 and multiple wireless communication devices 102.

Communications in the wireless communication system 100 may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. In some configurations, the wireless communication system 100 may utilize MIMO. A MIMO system may support time division duplex (TDD) and/or frequency division duplex (FDD) systems.

In some configurations, the wireless communication system 100 may operate in accordance with one or more standards. Examples of these standards include Bluetooth (e.g., Institute of Electrical and Electronics Engineers (IEEE) 802.15.1), Bluetooth low energy (BLE), IEEE 802.11 (Wi-Fi), IEEE 802.16 (Worldwide Interoperability for Microwave Access (WiMAX), Global System for Mobile Communications (GSM), Universal Mobile Telecommunications System (UMTS), CDMA2000, Long Term Evolution (LTE), etc. Accordingly, the wireless communication device 102 may communicate with a remote device using a communication protocol such as BLE in some configurations. In another configuration, the wireless communication device 102 may communicate with a remote device using radio-frequency identification (RFID) protocols.

In some configurations, the wireless communication system 100 may be a multiple-access system capable of supporting communication with multiple wireless communication devices 102 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO) systems, single-carrier frequency division multiple access (SC-FDMA) systems, General Packet Radio Service (GPRS) access network systems, 3rd Generation Partnership Project (3GPP) Long Term Evolution (LTE) systems, and spatial division multiple access (SDMA) systems.

In LTE and UMTS, a wireless communication device 102 may be referred to as a “user equipment” (UE). In 3GPP Global System for Mobile Communications (GSM), a wireless communication device 102 may be referred to as a “mobile station” (MS). The wireless communication device 102 and/or remote device may be referred to as and/or may include some or all of the functionality of a UE, MS, terminal, an access terminal, a subscriber unit, a station, etc. Examples of the wireless communication device 102 include cellular phones, smartphones, wireless headsets, wireless speakers, personal digital assistants (PDAs), wireless devices, electronic automobile consoles, gaming systems, wireless controllers, sensors, wireless modems, handheld devices, laptop computers, Session Initiation Protocol (SIP) phones, wireless local loop (WLL) stations, wearable devices, smart watches, sensors, package tracking beacons, etc.

The systems and methods described herein may be implemented on a variety of different electronic devices. Examples of electronic devices include general purpose or special purpose computing system environments or configurations, personal computers (PCs), server computers, handheld or laptop devices, multiprocessor systems, microprocessor-based systems, programmable consumer electronics, network PCs, minicomputers, mainframe computers, distributed computing environments that include any of the above systems or devices and the like. The systems and methods may also be implemented in mobile devices such as phones, smartphones, wireless headsets, personal digital assistants (PDAs), ultra-mobile personal computers (UMPCs), mobile Internet devices (MIDs), etc. Further, the systems and methods may be implemented by battery-operated devices, sensors, shipping labels, inventory control beacons, etc. The following description refers to wireless communication devices 102 for clarity and to facilitate explanation. Those of ordinary skill in the art will understand that a wireless communication device 102 may comprise any of the devices described above as well as a multitude of other devices.

In yet another configuration, the wireless communication device 102 may be implemented as a beacon device. For example, beacon devices are increasingly used to support tracking of assets and other objects. This application may be referred to as package tracking. For example, the wireless communication device 102 may be configured to attach to an object for inventory tracking. In another implementation, the wireless communication device 102 may be configured as a shipping label for package tracking.

The wireless communication device 102 may be configured with a transceiver 115 that includes a transmitter 111 and (optionally) a receiver 113. The transceiver 115 may send and/or receive wireless signals through an antenna. The wireless communication device 102 may also be configured with a battery 118 to power the transceiver 115 and other circuitry. For example, the wireless communication device 102 may include one or more controllers (e.g., a microcontroller, processor or microprocessor) and memory.

In an implementation, the wireless communication device 102 may be configured as a flat adhesive shipping label. The wireless communication device 102 may be attached (e.g., affixed with an adhesive) to a package for package tracking. In this case, the battery 118 of the wireless communication device 102 should have a small form factor that minimizes the thickness and expense of the wireless communication device 102. In one configuration, the battery 118 may be a coin cell. In another configuration, the battery 118 may be a printed battery.

In some implementations, the wireless communication device 102 may communicate using a Bluetooth low energy (BLE) protocols. The Bluetooth (BT) wireless communication standard is typically employed for exchanging communications between fixed or mobile Bluetooth-enabled devices over short distances. In some configurations, the systems and methods disclosed herein may be applied to Bluetooth-enabled devices configured to operate according to Bluetooth low energy (BLE) standards.

LE refers to the “Low Energy” extension of the Bluetooth standard. The BLE extension is focused on energy-constrained applications such as battery-operated devices, sensor applications, etc. The following description uses terminology associated with the Bluetooth and Bluetooth LE standards. Nevertheless, the concepts may be applicable to other technologies and standards that involve modulating and transmitting digital data. Accordingly, while some of the description is provided in terms of Bluetooth standards, the systems and methods disclosed herein may be implemented more generally in wireless communication devices 102 that may not conform to Bluetooth standards.

A BT device may include a transmitter 111, a receiver 113, or both a transmitter 111 and a receiver 113. A BT device may also use a frequency-hopping transceiver 115 to combat interference and fading.

BLE systems operate in the unlicensed 2.4 gigahertz (GHz) Industrial-Scientific-Medical (ISM) band at 2.400-2.4835 GHz (2400-2483.5 megahertz (MHz)). As part of the device discovery and connection setup procedure, a BT beacon may transmit advertising packets 120 on advertising channels. A remote BT device (e.g., a package scanner 104) may perform periodic scans on the advertising channels to detect these advertising packets 120.

In other implementations, the wireless communication device 102 may also be an RFID type beacon. RFID is a wireless communication technology that uses electromagnetic fields to communicate information. In one approach, RFID devices may use inductive coupling. For example, a magnetic field may be established between a wireless communication device 102 and a scanner 104. In this approach, a wireless communication device 102 may communicate information by modulating the magnetic field. In another approach, an RFID device may use capacitive coupling. In yet another approach, an RFID may use radio frequencies to communicate. For example, active, semi-passive and passive RFID tags may communicate with a scanner 104 over one or more radio frequencies.

A wireless communication device 102 may indicate its presence by transmitting advertising packets 120. For example, a wireless communication device 102 may transmit a plurality of advertising packets 120 at a given advertising rate 108. In some implementations, advertising packets 120 may be sent once every second, although the advertising rate 108 may be configurable based on the desired responsiveness of the system and operating parameters of scanners 104. Sending more advertising packets 120 (i.e., using a high advertising rate) may increase the detectability of the wireless communication device 102 at the expense of battery life. Sending fewer advertising packets 120 (i.e., using a low advertising rate) may increase the life of the battery 118 at the expense of the device detectability.

Devices that transmit advertising packets 120 on the advertising physical (PHY) channels may be referred to as advertisers. Devices that receive advertising packets 120 on the advertising channels without the intention to connect to the advertising device may be referred to as scanners 104. As used herein, a scanner 104 may be referred to as a receiver, a reader, a central device or the like.

When a large number of wireless communication devices 102 (e.g., Bluetooth Low Energy (BLE) devices, RFID devices) are in close proximity and are advertising to allow a central device (e.g., scanner 104) to sense and/or connect to the wireless communication devices 102, advertising packets 120 can be missed due to congestion of the radio channel(s). In an example, wireless communication devices 102 may be used as shipping labels that are affixed to packages or envelopes. With package tracking, at the place of origination of the package, there may be tens or maybe hundreds of different packages that are scanned by a scanner 104, picked up and put into a truck. In this case, the radio channel congestion may not be significant. However, once the packages get to a sorting facility, the packages may be stored and may wait to be processed. In this case there may be thousands of packages with wireless communication devices 102 all transmitting advertising packets 120 at the same time in a small area.

Therefore, a problem is allowing all of these wireless communication devices 102 to be active within the range of a receiver device (e.g., scanner 104) and still have decent throughput, without having too many collisions between the advertising packets 120 arriving at the same time interrupting the data. At the same time, it is important to provide for good responsiveness through an advertising rate 108 that is sufficiently high to allow a scanner 104 to detect the wireless communication devices 102 quickly.

In an example, there may be four thousand wireless communication devices 102 sitting within range of a scanner 104. In one approach, the advertising rate 108 of the wireless communication devices 102 may be set to advertise once every twenty, thirty or forty seconds so that there are not too many collisions between advertising packets 120. Lowering the advertising rate 108 results in a corresponding lengthening of the advertising interval between advertising packets 120. In the Bluetooth low energy specifications, this is an option for decreasing packet collisions. However, the problem with this approach is the scanner 104 may have to wait a considerable about of time (e.g., between one and several minutes) before the scanner 104 actually detects a wireless communication device 102. Therefore, in this approach, a package processing system must wait before it can actually process that wireless communication device 102. For example, the package with the wireless communication device 102 may be running down a conveyor belt, someone may be picking up a package and trying to put the package in a truck, or some other tracking activity may need to be performed.

In these cases, there is a need to minimize the delay for a scanner 104 to detect the wireless communication device 102. With a very long delay (e.g., several seconds or up to a minute) to detect the wireless communication device 102, the benefits of using wireless communication for package tracking are negated. For example, scanning a barcode on the package would be faster if a scanner 104 must wait a long period of time to detect a wireless communication device 102. Therefore, it is beneficial to provide a high advertising rate 108 (e.g., an advertising packet 120 transmitted approximately once per second) and improve the detectability of advertising packets 120 with the high advertising rate 108. This results in a very responsive tracking system.

The systems and methods described herein provide improved reception of advertising packets 120 transmitted by a wireless communication device 102. In an implementation, the wireless communication device 102 may be used in package tracking. However, the wireless communication device 102 may also be used in other applications. For example, the wireless communication device 102 may be used for any type of tracking of objects (e.g., equipment, medical devices, packages, inventory, etc.).

The wireless communication device 102 may improve advertising packet detectability by modulating the transmit (TX) power used to transmit advertising packets 120 while maintaining a fixed advertising rate 108. The advertising packets 120 may be transmitted according to certain configurable advertising parameters 106 that include the advertising rate 108, a high TX power level 110, a number (N_{HIGH}) 112 of high-power packets 120a, a low TX power level 114 and a number (N_{LOW}) 116 of low-power packets 120b.

The wireless communication device 102 may transmit a first sequence of high-power advertising packets 120a. The first sequence may include a number (N_{HIGH}) 112 of high-power advertising packets 120a. The wireless communication device 102 may then transmit a second sequence of low-power advertising packets 120b. The low-power advertising packets 120b may be transmitted at the same advertising rate 108 as the high transmit power advertising packets 120a. The second sequence may include a number (N_{LOW}) 116 of low-power advertising packets 120b. The number 116 of low-power advertising packets 120b is greater than the number 112 of high-power advertising packets 120a.

In an example, the wireless communication device 102 may keep a constant advertising rate 108 (e.g., 1.2 seconds), but the wireless communication device 102 may advertise 10% of the time at a high TX power level 110. Therefore, during 10% of the time, the wireless communication device 102 may transmit advertising packets 120 at a maximum power from the transmitter 111 (e.g., 0 to +4 dBm). When transmitting at maximum power, the wireless communication device 102 may be detectable over a large distance. For the remaining 90% of the time, the wireless communication device 102 may transmit advertising packets 120 at a low TX power level 114. In an implementation, the low TX power level 114 may be between 10-20 dB below the high TX power level 110. For example, the wireless communication device 102 may transmit at 0 dBm at high TX power level 110 and −15 dBm at the low TX power level 114.

By reducing the transmit power in the range of 10-20 dB below the high TX power level 110, the wireless communication device 102 may achieve isolation between the advertising packets 120. For example, reducing the transmit power by 10 dB may reduce the range of the transmission by half as compared to the high TX power level 110 of 0 to +4 dBm. Similarly, reducing the transmit power by 20 dB may reduce the range of the transmission by a quarter as compared to the high TX power level 110, and so forth. The low TX power level 114 may be configured to achieve a desired transmission range (i.e., distance at which the advertising packets 120 are detectable by a remote device).

In this example, a scanner 104 that is sitting in the middle of a room monitoring for all the packages in its vicinity, may only see 10% of the wireless communication devices 102 at any one time. In other words, the scanner 104 may detect the wireless communication devices 102 that are transmitting at a high TX power level 110. The rest of the 90% of the wireless communication devices 102 that are not transmitting at the high TX power level 110 may be too far away for the scanner 104 to detect.

During the first sequence, the wireless communication device 102 will turn on the transmitter 111 and transmit N_{HIGH} 112 high-power advertising packets 120a (e.g., 10 advertising packets 120a at high TX power 110). After the first sequence, the wireless communication device 102 may then lower the TX power (e.g., on the order of 10-20 dB). The wireless communication device 102 may then transmit another N_{LOW} 116 (e.g., 90) low-power advertising packets 120b at the same advertising rate 108 during the second sequence. The wireless communication device 102 may repeat the first and second sequences in a repeating cycle.

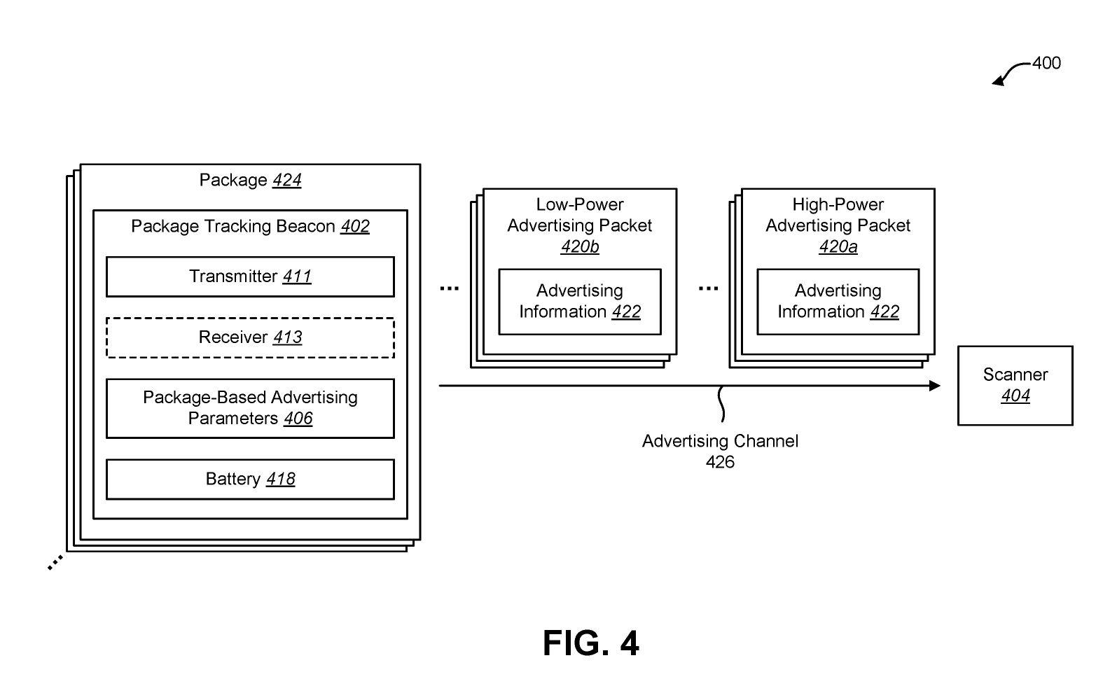

The actual amount of power that the wireless communication device 102 drops may be dependent on the type of object (e.g., package) to which the wireless communication device 102 is attached. For example, if the wireless communication device 102 is attached to a letter (e.g., envelope) that does not take up a lot of room, the wireless communication device 102 may use a different power ratio (e.g., the ratio of high TX power level 110 to low TX power level 114) than when attached to a large box. Large boxes physically take up more room. A scanner 404 is going to be farther away from a large box as compared to small satchels which can be contained in a very small area. The actual power ratio (also referred to as delta power) may be configurable based on the type of package or object to which the wireless communication device 102 is attached. An example of package-based advertising parameters is described in connection with FIG. 4.

In another example, the advertising parameters 106 may be configurable by a remote device. For example, when the wireless communication device 102 is first scanned upon being affixed to an object, the scanner 104 may establish a wireless link with the wireless communication device 102. The scanner 104 may communicate the values for the advertising parameters 106. These advertising parameter values may be configured based on the application of the wireless communication device 102, the type of object that is being tracked, the size of the tracked object, etc. Therefore, the advertising parameters 106 may be dynamic.

In another example, the advertising parameters 106 may be configured based on the progress of the wireless communication device 102 itself. For example, the wireless communication device 102 may be configured with a one set of advertising parameters 106 upon being scanned by a first scanner 104. The wireless communication device 102 may then be configured with a new set of advertising parameters 106 upon being scanned by a second scanner 104, and so forth. For example, the wireless communication device 102 may be configured to advertise with one set of advertising parameters 106 when it is scanned for transport in a truck and then configured with a different set of advertising parameters 106 when it is scanned at a sorting facility.

In an implementation, the advertising rate 108 may be configured based on the type of scanner 104 that is being used. For example, an advertising rate 108 may be used to accommodate the operating systems of a smartphone that is being used as a scanner 104. Therefore, interoperability with existing scanners 104 may be maximized by selecting a compatible advertising rate 108. Also, interoperability with scanners 104 may be enhanced by using a consistent advertising rate 108 for the sequences of high-power advertising packets 120a and low-power advertising packets 120b.

It should also be noted that the wireless communication device 102 does not simply alternate between high-power and low-power when transmitting advertising packets 120. Instead, the wireless communication device 102 transmits a sequence (e.g., two or more) of high-power advertising packets 120a followed by a longer sequence of low-power advertising packets 120b.

It should be noted that the wireless communication device 102 may also start with a long sequence of low-power advertising packets 120b followed by a short sequence of high-power advertising packets 120a. By transmitting multiple high-power advertising packets 120a, this gives the scanner 104 more time to detect a wireless communication device 102 when the wireless communication device 102 is actually transmitting as opposed to having to wait a longer time between each individual advertising packet 120. There may still be a number of collisions between transmitting units. However, if the first advertising packet 120 collides with another, by sending multiple (e.g., a second, third, fourth, fifth, etc.) advertising packets 120a at a high TX power level 110 fairly quickly, the scanner 104 has a higher probability of correctly detecting an advertising packet 120 from the wireless communication device 102.

The wireless communication device 102 may be configured to operate in the modulated TX power mode described herein. In some implementations, the wireless communication device 102 may operate at a high TX power level 110 all the time when it is initially activated. At a later time, the wireless communication device 102 may be triggered (e.g., forced) into the modulated TX power mode. In other implementations, the wireless communication device 102 may continually operate in the modulated TX power mode. Therefore, the modulated TX power mode may be continuous or may be configured (e.g., activated and/or deactivated based on conditions or commands).

Another benefit of the described power modulation for advertising packets 120 occurs in scenarios where there is little interference. For example, when a wireless communication device 102 is isolated from the other units (e.g., when there are few wireless communication devices 102 in close proximity) there is not as much interference. In this case, a scanner 104 may detect advertising packets 120b at the lower TX power level 114. For example, the wireless communication device 102 may be coming down a conveyor belt, and a scanner 104 may be right over or right under the conveyor belt. As the package passes the scanner 104, the scanner 104 may receive the advertising packets 120 whether they are high-power or low-power because the wireless communication device 102 is so close. In this case, the wireless communication device 102 saves power because it is transmitting advertising packets 120 primarily at the low TX power level 114.

However, when monitoring a large number of packages, a given package could physically take up a large space. In this case, the scanner 104 may not be close to all of the wireless communication devices 102 and low-power advertising packets 120b may not be picked up by the scanner 104. However, by transmitting high-power advertising packets 120a for a limited period of time, the scanner 104 may detect these advertising packets 120a without extra collisions.

The described systems and methods provide several benefits. One benefit is reducing the number of lost packets 120. Another benefit is using a consistent high advertising rate 108 that results in a responsive system. This is beneficial for scanning individual advertising packets 120 when the wireless communication device 102 is in an environment with a low number of advertising devices or when the wireless communication device 102 is close to a scanner 104. In these cases, the wireless communication devices 102 achieve good scan rates and response times by the scanner 104. However, by modulating the TX power levels, a scanner 104 may still monitor large collections of wireless communication devices 102 advertising at a high advertising rate 108. This is beneficial in environments with a high number (e.g., thousands) of wireless communication devices 102.

Another benefit is the ability to optimize the advertising rate 108 to a particular scanner 104 device. For example, the operating system of a scanner 104 may be an Apple® iOS or an Android®. Or the scanner 104 could be a custom scanner (having a proprietary operating system, for instance). The scanners 104 may have a particular scanning rate that may be optimized based on the configured advertising rate 108.

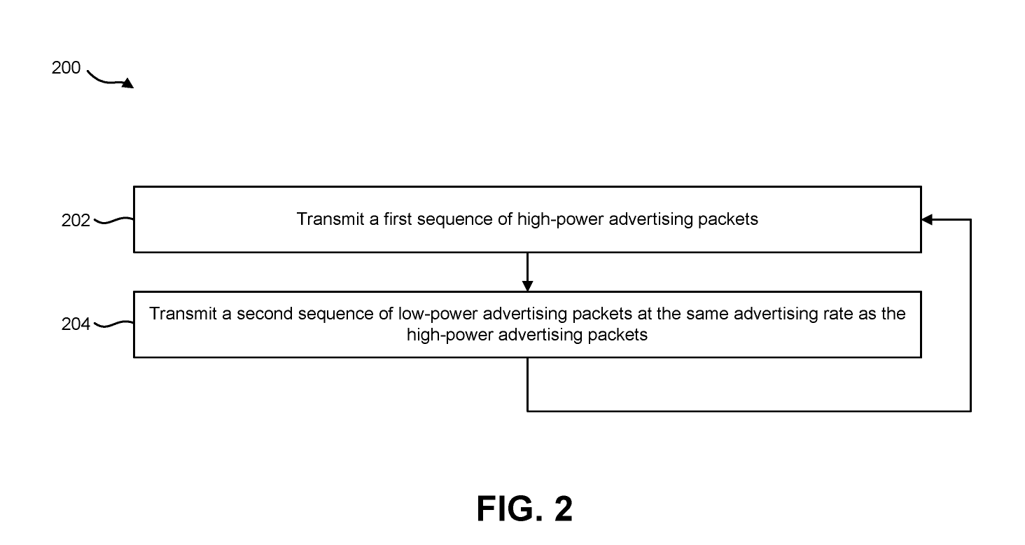

FIG. 2 is a flow diagram illustrating one configuration of a method 200 for improving reception of advertising packets 120 sent by a wireless communication device 102. In an implementation, the wireless communication device 102 may be a BLE device. In another implementation, the wireless communication device 102 may be an RFID device.

The wireless communication device 102 may be configured to attach to an object for inventory tracking. In some implementations, the wireless communication device 102 may be configured as a package tracking beacon. For example, the wireless communication device 102 may be configured as a shipping label for package tracking.

The wireless communication device 102 may transmit 202 a first sequence of high-power advertising packets 120a. The first sequence may include a number (N_{HIGH}) 112 of high-power advertising packets 120a. In an implementation, the first sequence may include between 5 and 10 high-power advertising packets 120a.

The advertising packets 120a in the first sequence may be transmitted at a given advertising rate 108. For example, the wireless communication device 102 may transmit the advertising packets 120a at a fixed rate of one advertising packet 120 every 1.2 seconds.

The wireless communication device 102 may transmit 204 a second sequence of low-power advertising packets 120b. The low-power advertising packets 120b may be transmitted at the same advertising rate 108 as the high-power advertising packets 120a. The second sequence may include a number (N_{LOW}) 116 of low-power advertising packets 120b. The number (N_{LOW}) 116 of low-power advertising packets 120b is greater than the number (N_{HIGH}) 112 of high-power advertising packets 120a.

In an implementation, the ratio of the number of low-power advertising packets 120b to high-power advertising packets 120a may be approximately 10:1, which may provide a balance between detectability and power savings. In other words, N_{LOW} 116 may be approximately 10 times N_{HIGH} 112. However, other ratios of the number of low-power to high-power advertising packets may be used.

The low transmit (TX) power level 114 of the low-power advertising packets 120b may be approximately 10 to 20 dB below the high TX power level 110 of the high-power advertising packets 120a. For example, the high TX power level 110 may be between 0 to +4 dBm and the low TX power level 114 may be between 10 to 20 dB below the high TX power level 110.

The high-power advertising packets 120a and the low-power advertising packets 120b may include the same advertising information 122. In other words, the high-power advertising packets 120a and the low-power advertising packets 120b may vary in the transmit power level used, but the advertising information 122 included in the advertising packets 120 may be the same. In an implementation, the advertising information 122 may include a unique identifier of the wireless communication device 102. Therefore, the high-power advertising packets 120a and the low-power advertising packets 120b perform the same functionality of identifying the wireless communication device 102. However, it should be noted that the purpose of the advertising packets 120 is not to establish a connection (e.g., wireless link) with the wireless communication device 102 to another device.

In some implementations, the advertising information 122 may include additional information (e.g., in addition to a unique identifier). For example, the advertising information 122 may include a manufacturer ID and/or status bits that indicate a fault with either the package or the beacon.

The first sequence and the second sequence repeat in one or more cycles. For example, after transmitting 204 the second sequence of low-power advertising packets 120b, the wireless communication device 102 may transmit 202 another sequence of high-power advertising packets 120a followed by another sequence of low-power advertising packets 120b and so forth.

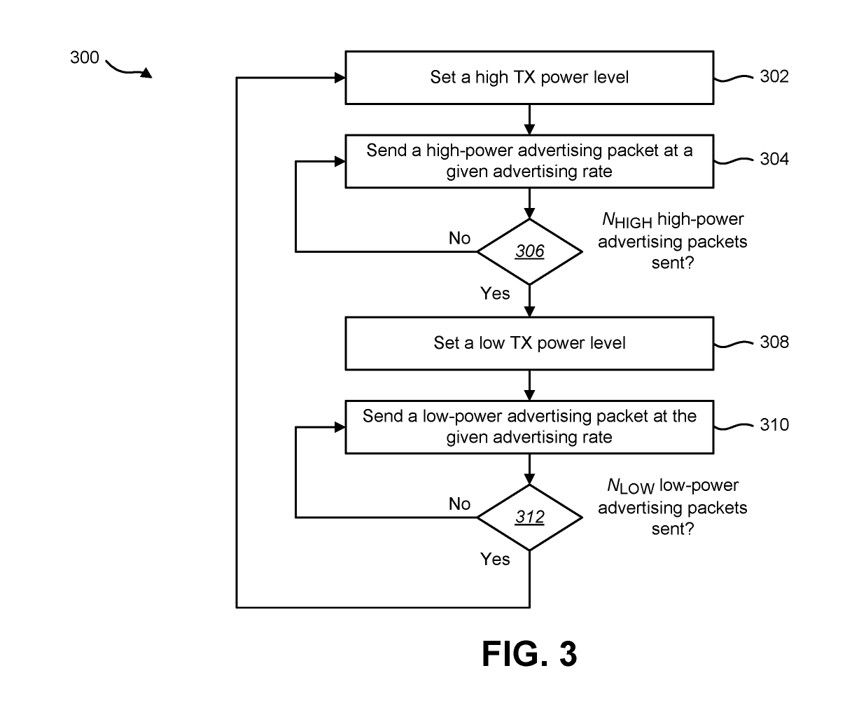

FIG. 3 is a flow diagram illustrating another configuration of a method 300 for improving reception of advertising packets 120 sent by a wireless communication device 102. The wireless communication device 102 may set 302 a high TX power level 110. For example, upon being activated, the wireless communication device 102 may set 302 the TX power level for a transmitter 111 to between 0 to +4 dBm.

The wireless communication device 102 may send 304 a high-power advertising packet 120a at an advertising rate 108. For example, the wireless communication device 102 may transmit an advertising packet 120a 120 at the high TX power level 110 according to a given advertising rate 108.

The wireless communication device 102 may determine 306 whether N_{HIGH} 112 high-power advertising packets 120a have been sent. N_{HIGH} 112 is the number of high-power advertising packets 120a in a sequence of high-power advertising packets 120a. If the number of transmitted high-power advertising packets 120a is less than N_{HIGH} 112, the wireless communication device 102 may continue sending 304 one or more high-power advertising packets 120a according to the advertising rate 108.

If wireless communication device 102 determines 306 that N_{HIGH} 112 high-power advertising packets 120a have been sent, the wireless communication device 102 may set 308 a low TX power level 114. The low transmit (TX) power level 114 may be approximately 10 to 20 dB below the high TX power level 110 of the high-power advertising packets 120a.

The wireless communication device 102 may send 310 a low-power advertising packet 120b at the advertising rate 108. The advertising rate 108 for the low-power advertising packets 120b may be the same as the advertising rate 108 used for the high-power advertising packets 120a.

The wireless communication device 102 may determine 312 whether N_{LOW} 116 low-power advertising packets 120b have been sent. N_{LOW} 116 is the number of low-power advertising packets 120b in a sequence of low-power advertising packets 120b. N_{LOW} 116 may be more than N_{HIGH} 112. In other words, the wireless communication device 102 may send 310 more low energy advertising packets 120b in the second sequence than the high-power advertising packets 120a sent in the first sequence. If the number of transmitted low-power advertising packets 120b is less than N_{LOW} 116, the wireless communication device 102 may continue sending 310 one or more low-power advertising packets 120b according to the advertising rate 108.

If the wireless communication device 102 determines 312 that N_{LOW} 116 low-power advertising packets 120b have been sent, the wireless communication device 102 may set 302 the transmitter 111 power to the high TX power level 110. The wireless communication device 102 may continue to cycle between a sequence of transmitting high-power advertising packets 120a followed by a sequence of transmitting low-power advertising packets 120b.

FIG. 4 is a block diagram illustrating a package tracking beacon 402. The package tracking beacon 402 may be implemented in accordance with the wireless communication device 102 described in connection with FIG. 1.

The package tracking beacon 402 may transmit advertising packets 420 on an advertising channel 426. For example, the package tracking beacon 402 may use Bluetooth low energy (BLE) protocols to transmit the advertising packets 420 on one or more advertising channels 426. A scanner 404 may perform scans to detect the advertising packets 420 on the one or more advertising channels 426.

In some implementations, the package tracking beacon 402 may be configured to attach to the package 424 with an adhesive. For example, a surface of the package tracking beacon 402 may be coated with an adhesive with which the package tracking beacon 402 may be bonded to the package 424. In other implementations, the package tracking beacon 402 may be configured to attach to the package 424 with non-adhesive attachment mechanisms (e.g., bands, straps, hook and loop systems, screws, nails, etc.). In yet other implementations, the package tracking beacon 402 may configured to be included within the package 424. For example, the package tracking beacon 402 may be configured with a flat shape that can easily fit within an envelope or box.

In some implementations, the package tracking beacon 402 may be a label (e.g., shipping label) associated with a package 424. For example, the package tracking beacon 402 may be configured as a flat, adhesive-backed shipping label. The package tracking beacon 402 may be attached (e.g., affixed with an adhesive) to the package 424 for package tracking.

The package tracking beacon 402 includes a transmitter 411 that transmits advertising packets 420 according to package-based advertising parameters 406. The package tracking beacon 402 may also include a battery 418 to provide power to the transmitter 411 and other circuitry (e.g., processor, memory, etc.). The package tracking beacon 402 may (optionally) include a receiver 413. For example, in one implementation, the package tracking beacon 402 may only include the transmitter 411 without a receiver 413. In this implementation, the package tracking beacon 402 may include a switch or other means of activating the transmission of advertising packets 420.

In an approach where the package tracking beacon 402 is implemented as a shipping label, the package tracking beacon 402 may initially have a backing (e.g., backing paper, plastic, liner) to protect the adhesive. The package tracking beacon 402 may be configured to start transmitting advertising packets 420 according to the package-based advertising parameters 406 when the backing from the adhesive label is removed.

In other (optional) implementations, the package tracking beacon 402 may include a receiver 413. In these implementations, a scanner 404 may communicate with the package tracking beacon 402. In this case, the package tracking beacon 402 may receive a command to start transmitting advertising packets 420 according to the package-based advertising parameters 406. For example, a user may attach the package tracking beacon 402 to a package 424. At some point, the package tracking beacon 402 may be scanned by a scanner 404 and the package tracking beacon 402 may start broadcasting advertising packets 420.

The package tracking beacon 402 may be configured with package-based advertising parameters 406. Different types of packages 424 may benefit from different advertising parameter configurations. For example, the expected density of packages 424 in a processing facility may vary depending on the type of package 424. Small envelopes or satchels may be placed in a greater density than large boxes. In other words, more small packages 424 may be placed in a given area than large packages 424.

In another example, the physical size of a package 424 may impact what advertising parameters 406 are used. For example, a scanner 404 may be located closer to a small package 424 as compared to a large package 424. Therefore, the advertising parameters 406 may be based on the type of package 424 used.

As described in connection with FIG. 1, the package-based advertising parameters 406 may include one or more of the following: the advertising rate 108; the high TX power level 110 used for transmitting high-power advertising packets 420a; the number (N_{HIGH}) 112 of high-power advertising packets 420a sent in a high-power advertising packet sequence; the low TX power level 114 used for transmitting low-power advertising packets 420b; and/or the number (N_{LOW}) 116 of low-power advertising packets 420b sent in a low-power advertising packet sequence. One or more of these package-based advertising parameters 406 may be configured for a package type.

The package tracking beacon 402 may send a sequence of high-power advertising packets 420a based on the package-based advertising parameters 406. The package tracking beacon 402 may then send a sequence of low-power advertising packets 420b based on the package-based advertising parameters 406. It should be noted that the advertising information 422 included in both the high-power advertising packets 420a and the low-power advertising packets 420b is the same. In an implementation, the advertising information 422 may include a unique identifier of the package tracking beacon 402. The scanner 404 may use the advertising information 422 to identify the package tracking beacon 402.

In an implementation, the package tracking beacon 402 may be a shipping label that is attached to a package 424. Different labels may be preconfigured with different package-based advertising parameters 406. For example, a shipping label used for a large package may be preconfigured with certain values for the high TX power level 110 and the low TX power level 114 that differ from a shipping label used for a small package. Therefore, by selecting a certain label type, different power levels (delta power) may be implemented. Additionally or alternatively, the values of N_{HIGH} 112 and N_{LOW} 116 may be configured differently for different label types. Furthermore, advertising rates 108 may be configured differently for different label types.

It should be noted that in this implementation, there is no need to connect to the package tracking beacon 402 and configure the package-based advertising parameters 406. Rather, the advertising parameters 406 are preconfigured based on the intended use of the package tracking beacon 402. Through selecting the type of label that is attached to a package 424, different package-based advertising parameters 406 may be achieved. Furthermore, in this implementation, no receiver 413 is required, and the package tracking beacon 402 may operate as a transmitter-only beacon.

In another implementation, the package-based advertising parameters 406 may be configurable by a scanner 404. In this implementation, the package tracking beacon 402 may include a receiver 413. When the package tracking beacon 402 is first scanned upon being affixed to the package 424, the scanner 404 may establish a wireless link with the wireless communication device 102. The scanner 404 may communicate the values for the package-based advertising parameters 406. These advertising parameter values may be configured based on the package type, the size of the package 424, the importance of the package 424 or other factors related to the package 424 or contents therein. Therefore, the package-based advertising parameters 406 may be dynamic.

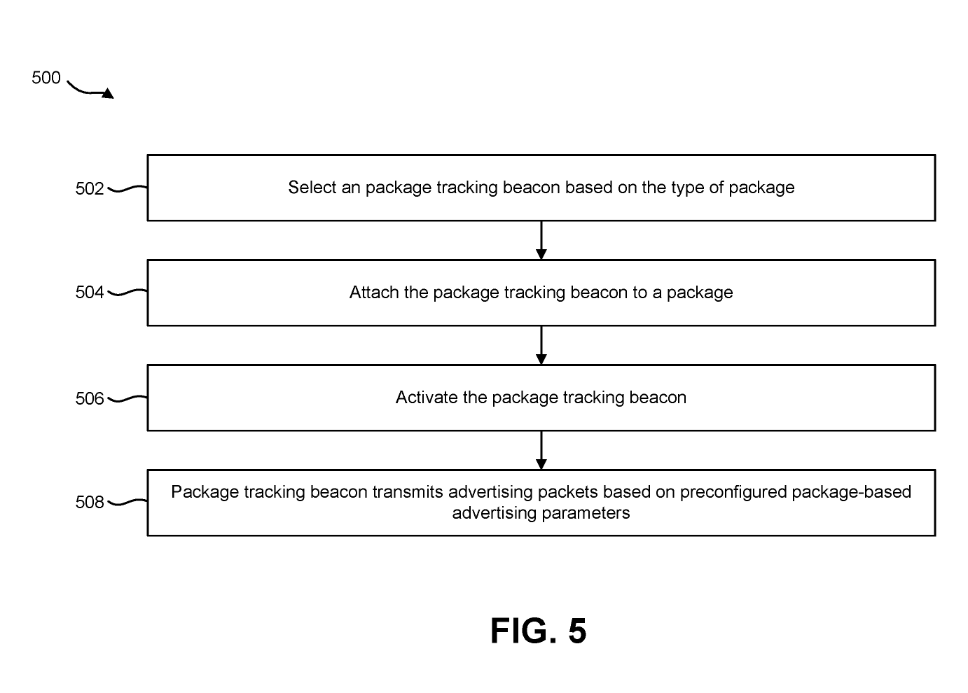

FIG. 5 is a flow diagram illustrating one configuration of a method 500 for improving reception of advertising packets 120 sent by a package tracking beacon 402. In this example, the package tracking beacon 402 may have a transmitter 411 but does not have a receiver 413.

In step 502, a package tracking beacon 402 may be selected based on a type of package 424. For example, the package tracking beacon 402 may be configured as a shipping label. Different shipping labels (i.e., package tracking beacons 402) may have different package-based advertising parameters 406. One type of shipping label may be pre-configured with advertising parameters 406 for envelopes, another type of shipping label may be pre-configured with advertising parameters 406 for small boxes, while yet another type of shipping label may be pre-configured with advertising parameters 406 for large boxes. A particular package tracking beacon 402 may be selected 502 for a particular type of package 424.

In step 504, the package tracking beacon 402 may be attached to the package 424. For example, the package tracking beacon 402 may be configured with one or more adhesive surfaces that attach to the package 424. In other implementations, the package tracking beacon 402 may be attached to the package 424 with mechanical fasteners. In yet another implementation, the package tracking beacon 402 may be configured to be placed within the package 424.

In step 506, the package tracking beacon 402 may be activated. For example, the package tracking beacon 402 may include an activation mechanism (e.g., button, switch, light sensor, accelerometer, etc.) that activates transmission of advertising packets 420. Before being activated in step 506, the package tracking beacon 402 may be in a powered-off state.

In step 508, the package tracking beacon 402 may transmit advertising packets 420 based on the preconfigured package-based advertising parameters 406. For example, the package-based advertising parameters 406 may be preconfigured depending on the type of shipping label that was selected in step 502. The package tracking beacon 402 may transmit a sequence of high-power advertising packets 420a followed by a sequence of low-power advertising packets 420b. The TX power and number of advertising packets 420 in each sequence may be determined according to the preconfigured package-based advertising parameters 406. Therefore, the advertising behavior for a given package 424 may be configured based on the type of shipping label that is selected.

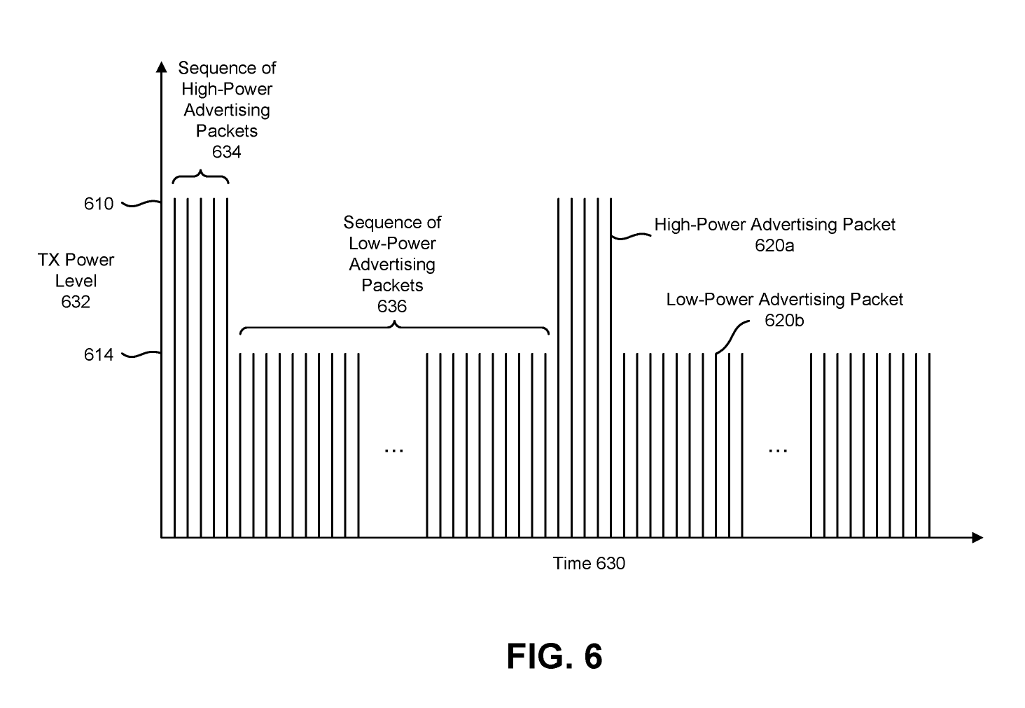

FIG. 6 is a graph illustrating advertising packet transmit pulses according to a modulated power level. The TX power level 632 of advertising packet transmit pulses is shown relative to time 630. A first sequence 634 of high-power advertising packets 620a is sent. The first sequence 634 may include N_{HIGH} 112 high-power transmit pulses. For example, 5 advertising packets 620a may be sent in the first sequence 634 of high-power advertising packets 620a.

A second sequence 636 of low-power advertising packets 620b may follow. The second sequence 636 may include N_{LOW} 116 low-power transmit pulses. The sequence 636 of low-power advertising packets 620b may be longer than the sequence 634 of high-power advertising packets 620a. For example, the wireless communication device 102 may send 90 low-power advertising packets 620b in the second sequence 636.

The wireless communication device 102 then repeats the cycle of a sequence 634 of high-power advertising packets 620a followed by a sequence 636 of low-power advertising packets 620b.

The duty cycle of high-power to low-power advertising packets 620 may be configured depending on how many wireless communication devices 102 are to be supported in a given area. For example, to support up to 4,000 advertising wireless communication devices 102 in a small area, a duty cycle of 10% high-power advertising packets 620a to 90% low-power advertising packets 620b may be used. The duty cycle may be adjusted based on the number of advertising packets 620 transmitted at high TX power level 610 versus low TX power level 614.

In an implementation, a sequence 634 of five advertising packets 620a may be transmitted at a high TX power level 610 and high advertising rate 108 (e.g., one packet every 1.2 seconds) followed by a long sequence 636 of low-power advertising packets 620b transmitted at the same advertising rate 108. This number of high-power advertising packets 620a may be enough to ensure that there are not too many collisions, while also ensuring that the wireless communication device 102 is reliably detected by a scanner 104. The high advertising rate 108 provides good responsiveness on both a large scale (e.g., many wireless communication devices 102) and a small scale (e.g., few wireless communication devices 102).

With many wireless communication devices 102 sitting in a room, it may be assumed that their advertising packet transmissions are randomly distributed to begin with. But if there are collisions, over a short period of time, the collisions resolve. For example, a packet error rate may be high for one advertising packet 620, but by the next few (e.g., 1 or 2) advertising packets 620, the error rate may be totally uncorrelated.

This is one of the main reasons for not simply transmitting one high-power advertising packet 620a every 10 seconds, or every 15 seconds. With a short sequence 634 of high-power advertising packets 620a, there can easily be collisions for 1 or 2 packets 620a, but it is highly unlikely 3 packets 620a in a row will collide. By the time 5 advertising packets 620a are sent in a row, it is extremely unlikely that all 5 advertising packets 620a would be lost.

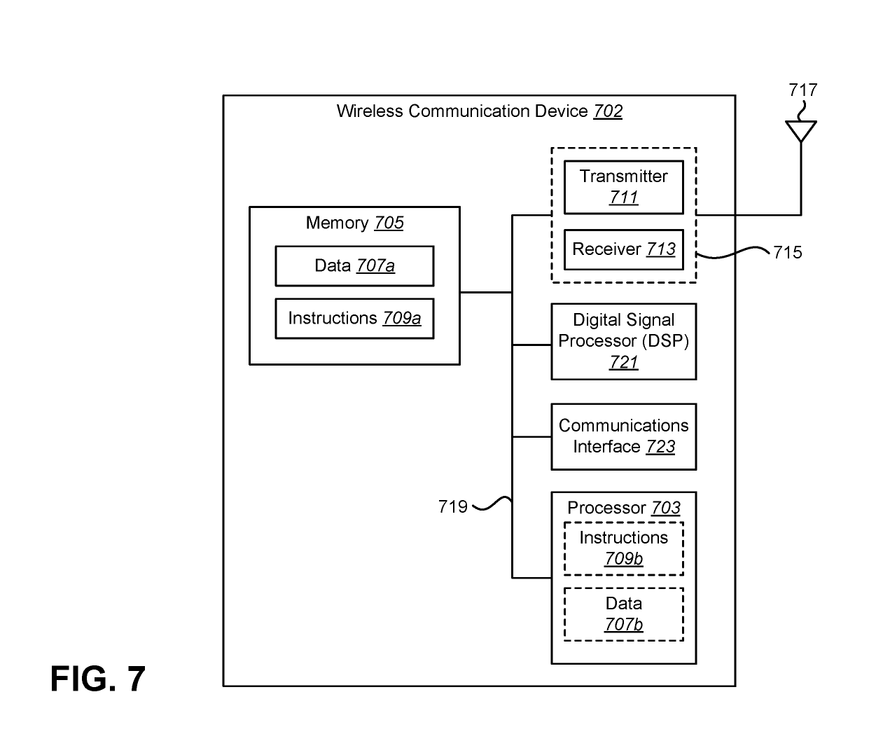

FIG. 7 illustrates certain components that may be included within a wireless communication device 702. The wireless communication device 702 described in connection with FIG. 7 may be an example of and/or may be implemented in accordance with the wireless communication device 102 and/or package tracking beacon 402 described in connection with one or more of FIGS. 1-6.

The wireless communication device 702 includes a processor 703. The processor 703 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 703 may be referred to as a central processing unit (CPU). Although just a single processor 703 is shown in the wireless communication device 702 of FIG. 7, in an alternative configuration, a combination of processors (e.g., an ARM and DSP) could be used.

The wireless communication device 702 also includes memory 705 in electronic communication with the processor (i.e., the processor can read information from and/or write information to the memory). The memory 705 may be any electronic component capable of storing electronic information. The memory 705 may be configured as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers and so forth, including combinations thereof.

Data 707a and instructions 709a may be stored in the memory 705. The instructions may include one or more programs, routines, sub-routines, functions, procedures, code, etc. The instructions may include a single computer-readable statement or many computer-readable statements. The instructions 709a may be executable by the processor 703 to implement the methods disclosed herein. Executing the instructions 709a may involve the use of the data 707a that is stored in the memory 705. When the processor 703 executes the instructions 709, various portions of the instructions 709b may be loaded onto the processor 703, and various pieces of data 707b may be loaded onto the processor 703.

The wireless communication device 702 may also include a transmitter 711 and a receiver 713 to allow transmission and reception of signals to and from the wireless communication device 702 via an antenna 717. The transmitter 711 and receiver 713 may be collectively referred to as a transceiver 715. The wireless communication device 702 may also include (not shown) multiplier transmitters, multiplier antennas, multiplier receivers and/or multiplier transceivers.

The wireless communication device 702 may include a digital signal processor (DSP) 721. The wireless communication device 702 may also include a communications interface 723. The communications interface 723 may allow a user to interact with the wireless communication device 702.

The various components of the wireless communication device 702 may be coupled together by one or more buses, which may include a power bus, a control signal bus, a status signal bus, a data bus, etc. For the sake of clarity, the various buses are illustrated in FIG. 7 as a bus system 719.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C.

As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C.

As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

The functions described herein may be implemented in software or firmware being executed by hardware. The functions may be stored as one or more instructions on a computer-readable medium. The terms “computer-readable medium” or “computer-program product” refer to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method by a wireless communication device, comprising:
transmitting a first sequence of high-power advertising packets; and
transmitting a second sequence of low-power advertising packets at a same advertising rate as the high-power advertising packets, the high-power advertising packets and the low-power advertising packets including the same advertising information,
wherein the first sequence and the second sequence repeat in one or more cycles.

2. The method of claim 1, wherein the first sequence includes a number of high-power advertising packets and the second sequence includes a number of low-power advertising packets, wherein the number of low-power advertising packets is greater than the number of high-power advertising packets.

3. The method of claim 1, wherein the first sequence includes between 5 and 10 high-power advertising packets.

4. The method of claim 1, wherein a ratio of low-power advertising packets to high-power advertising packets is approximately 10:1.

5. The method of claim 1, wherein a ratio of high-power advertising packets to low-power advertising packets is based on an expected density of advertising devices in an area.

6. The method of claim 1, wherein a ratio of high-power advertising packets to low-power advertising packets is based on a package type to which the wireless communication device is attached.

7. The method of claim 1, wherein a low transmit (TX) power level of the low-power advertising packets is approximately 10 to 20 decibels (dB) below a high TX power level of the high-power advertising packets.

8. The method of claim 1, wherein the wireless communication device is a Bluetooth low energy (BLE) device.

9. The method of claim 1, wherein the wireless communication device is a radio-frequency identification (RFID) device.

10. The method of claim 1, wherein the wireless communication device is configured to attach to an object for inventory tracking.

11. The method of claim 1, wherein the wireless communication device is configured as a shipping label for package tracking.

12. The method of claim 1, wherein the wireless communication device is package tracking beacon having a transmitter and no receiver.

13. A wireless communication device, comprising:
a processor;
a memory in electronic communication with the processor; and
instructions stored in the memory, the instructions executable by the processor to:
transmit a first sequence of high-power advertising packets; and
transmit a second sequence of low-power advertising packets at a same advertising rate as the high-power advertising packets, the high-power advertising packets and the low-power advertising packets including the same advertising information,
wherein the first sequence and the second sequence repeat in one or more cycles.

14. The wireless communication device of claim 13, wherein the first sequence includes a number of high-power advertising packets and the second sequence includes a number of low-power advertising packets, wherein the number of low-power advertising packets is greater than the number of high-power advertising packets.

15. The wireless communication device of claim 13, wherein a ratio of low-power advertising packets to high-power advertising packets is approximately 10:1.

16. The wireless communication device of claim 13, wherein a ratio of high-power advertising packets to low-power advertising packets is based on a package type to which the wireless communication device is attached.

17. The wireless communication device of claim 13, wherein a low transmit (TX) power level of the low-power advertising packets is approximately 10 to 20 decibels (dB) below a high TX power level of the high-power advertising packets.

18. The wireless communication device of claim 13, wherein the wireless communication device is a Bluetooth low energy (BLE) device.

19. The wireless communication device of claim 13, wherein the wireless communication device is configured as a shipping label for package tracking.

20. A non-transitory tangible computer readable medium, the computer readable medium storing computer executable code, comprising:
code for causing a wireless communication device to transmit a first sequence of high-power advertising packets; and
code for causing the wireless communication device to transmit a second sequence of low-power advertising packets at a same advertising rate as the high-power advertising packets, the high-power advertising packets and the low-power advertising packets including the same advertising information,
wherein the first sequence and the second sequence repeat in one or more cycles.

21. The computer readable medium of claim 20, wherein the first sequence includes a number of high-power advertising packets and the second sequence includes a number of low-power advertising packets, wherein the number of low-power advertising packets is greater than the number of high-power advertising packets.

22. The computer readable medium of claim 20, wherein a ratio of low-power advertising packets to high-power advertising packets is approximately 10:1.

23. The computer readable medium of claim 20, wherein a low transmit (TX) power level of the low-power advertising packets is approximately 10 to 20 decibels (dB) below a high TX power level of the high-power advertising packets.

24. The computer readable medium of claim 20, wherein a ratio of high-power advertising packets to low-power advertising packets is based on a package type to which the wireless communication device is attached.

25. The computer readable medium of claim 20, wherein the wireless communication device is configured as a shipping label for package tracking.

26. An apparatus for wireless communication, comprising:
means for transmitting a first sequence of high-power advertising packets; and
means for transmitting a second sequence of low-power advertising packets at a same advertising rate as the high-power advertising packets, the high-power advertising packets and the low-power advertising packets including the same advertising information,
wherein the first sequence and the second sequence repeat in one or more cycles.

27. The apparatus of claim 26, wherein the first sequence includes a number of high-power advertising packets and the second sequence includes a number of low-power advertising packets, wherein the number of low-power advertising packets is greater than the number of high-power advertising packets.

28. The apparatus of claim 26, wherein a ratio of low-power advertising packets to high-power advertising packets is approximately 10:1.

29. The apparatus of claim 26, wherein a ratio of high-power advertising packets to low-power advertising packets is based on a package type to which the apparatus is attached.

30. The apparatus of claim 26, wherein the apparatus is configured as a shipping label for package tracking.
